(19) United States
(12) Patent Application Publication
(10) Pub. No.: US 2002/0078107 A1
(43) Pub. Date: Jun. 20, 2002

(54) Graphing calculator with X=editor for equations and inequalities

(76) Inventors: Michelle A. Miller, Plano, TX (US); Jian Zhang, Dallas, TX (US)

Correspondence Address: TEXAS INSTRUMENTS INCORPORATED, P O BOX 655474, M/S 3999, DALLAS, TX, 75265

(21) Appl. No.: 09/742,035

(22) Filed: Dec. 20, 2000

(51) Int. Cl. G06F 1/00; G06T 1/00

(52) U.S. Cl. 708/131; 345/522

(57) ABSTRACT

A graphing calculator (10) or other computer based teaching tool having an X=Editor with equations and inequalities. The calculator (10) is programmed to provide an X=Editor which displays one or more “X=” to allow input of a vertical line equation or inequality. The X=Editor allows the user to input a relational symbol and a constant for each X, allows the user to select or deselect each X, and a graph function to graph each selected X on the X=Editor display.

### TECHNICAL FIELD OF THE INVENTION

This invention relates to computer based teaching tools such as electronic calculators, and more particularly to a calculator or other computer teaching tool having an X=Editor to allow input of equations and inequalities.

### BACKGROUND OF THE INVENTION

Electronic calculators have become a common tool for teaching students mathematics. In particular, the advantages of graphing calculators are being utilized in the classroom. Graphing calculators are characterized by a larger screen, which permits the entry of mathematical expressions in a logical format. They also permit graph displays and table displays. They have sophisticated programming capability. They often permit data transmission to other computing devices, directly or via a data storage medium, as well as data collection via various interface protocols. Particular calculator models are often designed for particular educational levels. For example, a calculator for middle school students might have less advanced features than one designed for older students. However, regardless of the level for which a calculator is designed, a continual goal in designing them is to provide a logical and easy-to-use interface.

### SUMMARY OF THE INVENTION

One aspect of the invention is a graphing calculator that provides an X=Editor user interface function. While prior art calculators would allow entry of a vertical line, they did not allow input in an equation format with a user option of selecting an equation (=sign) or an inequality (other relational symbols like >, <, ≧, or ≦).

The calculator may be otherwise a conventional graphing calculator. Namely, the calculator screen is capable of two-dimensional displays and of displaying at least straight lines in any direction and a cursor. A key panel has keys at least capable of selecting positions of the cursor and moving the cursor horizontally or vertically on said screen. A processor is operable to execute an X=editor programming that instructs the processor to perform the following steps: display one or more “X=” prompts, allow user input of an equation or inequality and a constant for each X, allow user to select or deselect each X, and display each selected X on the display.

In an embodiment of the invention a calculator permits vertical lines to be drawn using an intuitive, mathematical pedagogical interface, which increases understandability for the student and simplicity of the operation.

In a further embodiment of the invention, entry of vertical lines with inequalities is made with relational symbols in the format “X(relational symbol) constant.”

In another embodiment, the vertical line inequalities from the X=Editor can be graphed to indicate the inequality in a mathematically correct representation on the calculator output screen. In a preferred embodiment, the graphed line type is determined automatically by the inequality symbol chosen.

In another embodiment, an X=Editor interface function as described above is incorporated into other computer based teaching tools.

### BRIEF DESCRIPTION OF THE DRAWINGS

FIG. 1 illustrates the front panel of a calculator 10 having the X=Editor features of the present invention.

FIG. 2 illustrates the basic steps of using the calculator to use the X=Editor in accordance with the invention.

FIG. 3 illustrates an example of entering three inequalities or equations in the X=Editor.

FIG. 4 illustrates the graph of X₁<5.

FIG. 5 illustrates the graph of X₂≦5.

FIG. 6 illustrates the graph of X₃=3.

### DETAILED DESCRIPTION OF THE INVENTION

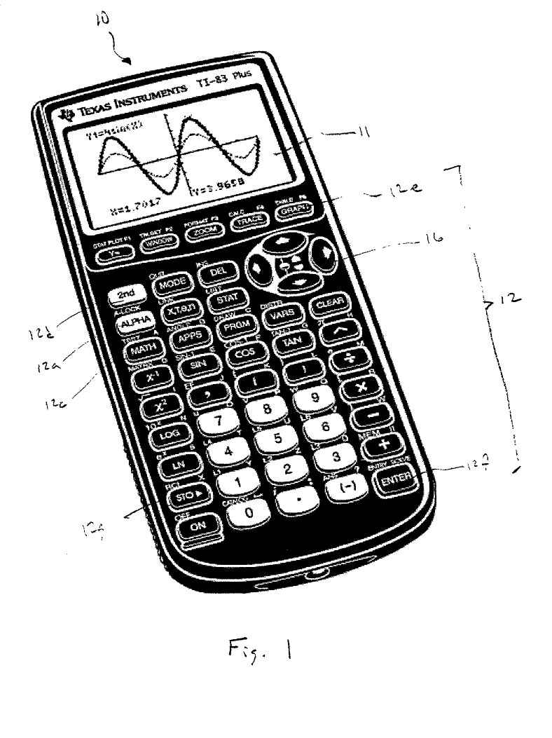

FIG. 1 illustrates the front panel of a calculator 10, which has the X=editor features of the present invention. Calculator 10 is described herein in terms of particular software and hardware features of the TI-83 Plus, a commercially available graphing calculator manufactured by Texas Instruments Incorporated. Apart from the features of the present invention, many of the features of calculator 10 described herein are typical of graphing calculators, while other features are unique to the TI-83 Plus or to its “family” of TI calculators. The use of the TI-83 Plus is for purposes of description, and does not limit the invention. The features that are the subject of the present invention could be incorporated into other calculators that provides graphical displays, or they could be incorporated into other computer based teaching tools and handheld computers.

In FIG. 1, the screen 11 of calculator 10 has a “graphical display”, as that term is used herein. In addition to the ability to draw graphical displays of various types, some of the software features of calculator 10 include, software applications loading and storage, keystroke programming. It also permits data collection, display and analysis.

Various hardware features include a large pixel screen 11, which is 64×96 pixels. A keypad 12 has various keys for data and command entry, some of which are used to implement the invention and are described herein. Other features are an I/O port for data linking, a 32 K byte RAM and 160 K byte application space, and a unit to unit link cable connection capability.

As is typical of calculators, calculator 10 has a secondary function key, 2nd key 12a, which permits other keys to have two functions. For example, by pressing 2nd key 12a and then Stat/List key 12b, the user enters the statistical functionality. For simplicity of explanation herein, a key having two functions is referred to in terms of the function appropriate for the context, i.e., when discussing the Stat function, Stat/List key 12b is referred to as the Stat key 12b. Similarly, calculator 10 has an Alpha key 12c, which when depressed makes the other keys subsequently depressed to input an alpha character.

FIG. 2 illustrates the basic steps of using calculator 10 to input vertical lines with optional shading using an X=Editor in accordance with the invention. FIG. 2 is drawn from the point of view of steps performed by the user. However, the same steps could be described in terms of activities performed by the computer. For example, steps involving entry of data by the user could also be described as receipt of data by the calculator.

The basic steps described in FIG. 2 are as follows: Invoke the X=Editor to display one or more “X=” prompt, allow user to select the desired relational symbol, allow the user to enter a constant for each X, allow the user to select or deselect each X, and display each selected X on the display. The steps of selection may be repeated for each X. These steps are further described with reference to FIG. 3.

FIG. 3 illustrates an example of the screen display for an X=Editor. In a preferred embodiment, the X=Editor is displayed by pressing the “APPS” key and then selecting the inequality graphing software application. In this embodiment, the X=Editor is a software application that resides in read/write memory in the calculator. In another embodiment, the X=Editor could be displayed by pressing a dedicated key on the keyboard to invoke permanent software code or hardwired electronics to produce the described functions herein.

Again referring to FIG. 3, in the top left hand comer of the display, the symbol “Y=” functions as a switch to toggle the display to the Y=Editor display( the Y=Editor is not described herein but is known in the prior art). Similarly, when the display is showing the Y=Editor, the symbol “X=” is shown in this position. In a preferred embodiment, the “Y=” or “X=” is highlighted to show that the user has defined and selected equations or inequalities on the other editor.

The display also includes several Xₙ lines, which allow the user to input vertical lines with inequalities. Each Xₙ line initially has the format of “\Xₙ=”, where n is a number between 1 and 6. The symbol preceding the “X”, initially a “\” symbol, represents the line type and inequality shading. The “=” symbol is in the position after the “Xₙ” and can be replaced with an inequality symbol as described below.

The next step is to select the inequality symbol for each Xn. The user of the graphing calculator uses the cursor direction keys 16 to move the cursor around the X=Editor display shown in FIG. 3. In the preferred embodiment, when the cursor is moved to the position of the relational symbol for any Xₙ the available relational symbols are displayed on the last line of the display as shown in FIG. 3. The user is then able to change the relational symbol at the cursor location by pressing the alpha key followed by the key directly below the desired symbol on the display. In FIG. 3, X₁ is shown with inequality “<”, X₂ with inequality “≦”, and X₃ with inequality “=”.

In a preferred embodiment, when the inequality symbol is selected the corresponding line type is set to graph the inequality. The line type for “<” is shown as a dotted line with the lower portion shaded. The line type for “≦” is shown as a solid line with the lower portion shaded. Similarly, a “>” symbol (not shown) could be represented with a dotted line with the upper portion shaded and a “≧” symbol with a solid line with the upper portion shaded.

The next step is to select a constant for each vertical line Xₙ to be graphed. The user uses the cursor direction key 16 to move to the constant position for any line Xₙ. In FIG. 3, X₁ is shown with constant “5”, X₂ with constant “5”, and X₃ with constant “3”. The constant need not be limited to integers but could be any real number.

In a preferred embodiment, the next step is to select which of the Xₙ lines of the display shown in FIG. 3 are to be graphed. In a preferred embodiment, the Xₙ lines of the X=Editor are not all displayed even though they may have been defined by the user as described above. Each Xₙ line can be activated or inactivated. The Xₙ lines are activated or inactivated by placing the cursor over the inequality symbol and pressing the “Enter” (12f) key. In a preferred embodiment, the inequality symbol for the selected k line is then displayed as a highlighted or reverse video symbol. FIG. 3 shows the X₁ symbol, “<” as a selected inequality to be displayed.

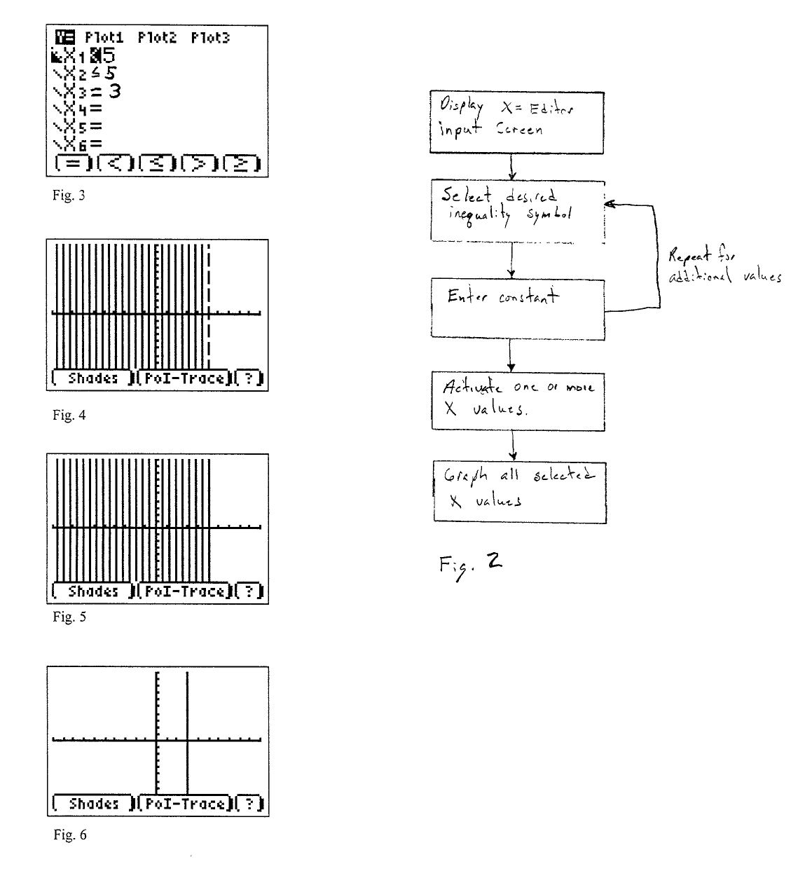

FIG. 4 illustrates an inequality display as defined by the X=Editor of FIG. 3. The graph of FIG. 4 illustrates the inequality X₁<5. Thus, the graph is a shaded area of all the coordinates to the left of but not including a vertical line at X=5. In a preferred embodiment, the inequality is shown in the graph by making the vertical line at X=5 a broken or dotted line. This readily illustrates to the user in a visual way that the graph does not include coordinates with the value of X equal to 5.

FIG. 5 illustrates another inequality display as defined by the X=Editor of FIG. 3. The graph of FIG. 4 illustrates the inequality X₂<5. Therefore the graph is a shaded area of all the coordinates to the left of and including a vertical line at X=5. In a preferred embodiment, an inequality which includes the value of the constant, in this case “5”, is shown with a solid line.

FIG. 6 illustrates another display as defined by the X=Editor of FIG. 3. The graph of FIG. 4 illustrates the equation X₃=3. Therefore the graph is a solid vertical line at X=3.

Other Embodiments

Although the present invention has been described in detail, it should be understood that various changes, substitutions, and alterations can be made hereto without departing from the spirit and scope of the invention as defined by the appended claims. For example, the invention could be incorporated into other handheld computer devices, or personal computer based teaching tools to provide to the student the same advantageous and novel learning aid claimed herein.

What is claimed is:

1. A graphing calculator that provides an X=Editor comprising:
a display screen,
a cursor on the display screen;
a key panel having keys at least capable of selecting positions of said cursor on said display screen;
a processor for executing X=Editor programming that instructs said processor to perform the following steps:
a) display an X=Editor input screen on the display screen with one or more “X=” prompts which allow a user to define one or more equations or inequalities,
b) allow the user to select at least one of said “X=” prompts and then select a relational symbol and a constant for each “X=” prompts, and
c) display each selected equation or inequality on the display as a line having a line type.

2. The graphing calculator of claim 1, wherein said processor is further programmed to display the inequality symbols available for the user to select on the display when the cursor is over the position of the relational symbol in the “X=” prompt.

3. The graphing calculator of claim 1, wherein said processor is further programmed to allow the user t o select or deselect each defined equation or inequality for display prior to step c.

4. The graphing calculator of claim 1, wherein the line type for displaying the graph of each selected equation or inequality is determined by which relational symbol is selected for that “X=” prompt.

5. The graphing calculator of claim 4, wherein the line type for each equation or inequality is displayed on the graph display by a symbol that represents that line type.

6. The graphing calculator of claim 4, wherein the line type for “<” and “>” is a broken line and the line type for “=”, “≦” and “≧” is a solid line.

7. The graphing calculator of claim 5, wherein the line type for “<” and “>” is a broken line and the line type for “=”, “≦” and “≧” is a solid line.

8. The graphing calculator of claim 1, wherein the line type for “<” and “>” is a broken line and the line type for “=”, “≦” and “≧” is a solid line.

9. A method to allow a user to input and graph equations or inequalities on a calculator comprising the steps of:
displaying an X=Editor having one or more lines of the format Xₙ (relational symbol)(Constant);
allowing the user to select the relational symbol for one or more
allowing the user to enter the constant for one or more xₙ , and
graphing one or more Xₙ equations or inequalities in response to an input from the user.

10. The method of claim 9, further comprising the steps of receiving an input from the user to activate or inactivate at least one Xₙ.

11. The method of claim 9, wherein said step for allowing the user to select the relational symbol for one or more Xₙ further includes selecting the line type to be graphed according to the relational symbol chosen.

12. The method of claim 11, wherein the line graphed comprises a broken line for “<” and “>” relational symbols and a solid line for relational symbols “=”, “≦”, and “≧” at the chosen constant position on the graph.

13. The method of claim 9, wherein the X=Editor display shows the relational symbols available for the user to select on the bottom of the display when the cursor is over the position of the relational symbol in the “X=” prompt.

14. The method of claim 9, wherein the X=Editor display includes a symbol which allows the user to switch to the Y=Editor display when the symbol is selected by the cursor.

15. The method of claim 14, wherein the symbol which allows the user to switch to a Y=Editor indicates whether there are activated equations defined on the Y=Editor display.

16. A computer based mathematics teaching tool that provides an X=Editor comprising:
a screen capable of displaying at least straight lines in any direction and a cursor;
a key panel having keys at least capable of selecting positions of said cursor on said screen;
a processor for executing X=Editor programming that instructs said processor to perform the following steps:
a) display an X=Editor input screen with one or more “X=” lines which allow a user to define one or more inequalities,
b) allow the user to select at least one of said “X=” lines and then select an inequality symbol and a constant for each “X=” line, and
c) display each selected inequality on the display as a line having a line type.

17. The computer based mathematics teaching tool of claim 16, wherein said processor is further programmed to display the inequality symbols available for the user to select on the display when the cursor is over the position of the inequality symbol in the X=line.

18. The computer based mathematics teaching tool of claim 16, wherein the line type for displaying the graph of each selected inequality is determined by which inequality symbol is selected for that inequality.

19. The computer based mathematics teaching tool of claim 19, wherein the line type for each inequality is displayed on the graph display by a symbol that represents that line type.
